(19) United States
(12) Patent Application Publication
(10) Pub. No.: US 2025/0148467 A1
(43) Pub. Date: May 8, 2025

(54) SYSTEM AND METHOD FOR AN ANTIFRAUD SCORING SYSTEM

(71) Applicant: REWIRE HOLDING LTD., London (GB)

(72) Inventors: Jesus Ruiz GONZALEZ, London (GB); Jose Luis Merino GONZALEZ, London (GB)

(21) Appl. No.: 18/730,433

(22) PCT Filed: Jan. 19, 2023
(86) PCT No.: PCT/GB2023/050097

§ 371 Date: Jul. 19, 2024

(30) Foreign Application Priority Data
Jan. 19, 2022 (GB) 2200635.7

(51) Int. Cl. G06Q 20/40; G06Q 20/32

(52) U.S. Cl. CPC G06Q 20/4015; G06Q 20/3224; G06Q 20/4016

(57) ABSTRACT

There is disclosed an antifraud system including a plurality of internet enabled wireless mobile devices and at least one payments server device, each respective internet enabled wireless mobile device including at least one respective transceiver being a respective cellular phone network transceiver, a respective non-transitory storage medium, and a respective computer program product embodied on the respective non-transitory storage medium, the respective computer program product executable on the respective internet enabled wireless mobile device to communicate with the payments server device and the payments server device including at least one internet enabled interface, a server non-transitory storage medium, and a server computer program product embodied on the server non-transitory storage medium, the server computer program product executable on the payments server device to communicate with the internet enabled wireless mobile devices. Related computer-implemented methods and computer program products are disclosed.

### BACKGROUND OF THE INVENTION

### 1. Field of the Invention

The field of the invention relates to computer-based antifraud systems, for example including an antifraud scoring system, and to related computer-implemented methods.

### 2. Technical Background

Legacy banking or payments processing firms have been evolving from traditional customer acquisition processes, where the customer needed to go to the bank branch to open an account, to a full digital process where a customer can open an account from a smartphone or any other electronic device with internet access.

However, this digital transformation became an opportunity for fraudsters to take advantage of the reasonably new digital era, as suddenly it became easier than before to avoid the security controls when creating new accounts remotely online.

Many legacy banks still require their customers to visit a physical high-street branch to finalize the onboarding/know-your-customer (KYC)—or know-your-business (KYB)—process, as they need to review the documentation with an in-person interview in some cases, including a personal identification (ID) verification of the client, with the ID document being checked by a bank employee and manual approval of the account opening.

Despite the amazing improvements in digital onboarding services and a wide variety of competing companies to choose from by end-users, there are still certain shortcomings that need to be improved or overcome.

Some of the shortcomings of the prior art;

(i)—in the case of a KYC- or KYB-process, most firms rely on basic solutions that makes the user visit a branch to show the documents. This makes the process safer, but you can only add users by a slow manual review process. This method has a high cost of acquisition of new users and makes the business difficult and expensive to scale in a digital world during or post the COVID era where users look for remote online solutions from the comfort of their homes using their mobile device or personal computer (PC).

(ii)—in the case of legacy firms, and most digital only firms, they still make use of traditional methods to collect information about the user, like, for example, trusting the internet protocol (IP) address. These unsafe methods may mark potentially fraudulent users as legitimate users, and may give the company a false sensation of being sufficiently protected from fraud.

(iii)—legacy firms, and most digital only firms, are exposed to new user accounts having been created with fake or false information or falsified documents. A user account based on fake information is more likely to be used to commit a criminal act such as, but not limited to, fraud or money laundering (ML) or in some extreme cases terrorist financing (TF).

(iv) many of the users with bad intentions that provide incorrect or inconsistent information are at high risk of committing a financial or criminal offense like ML/TF/Fraud. In particular when a user lies or provides false information about the country where he/she resides, that's when the correlation to committing a future offense is extremely high, and in this case the prior art shortcomings are in using those features that experienced users with bad intent know how to circumvent well, such as but not limited to using VPNs (virtual private networks) to mask their real country of connection and showing a different country to the connection country and so forth. Where forcing all users to allow access to global positioning systems (GPS) location data could mitigate this, it is an aggressive way to force the high percentage of honest users to allow access to more data on their devices. But even in this aspect the prior art has shown in the past spoofing of the GPS location to make a device think it is in a different location or country than it really was. This very important shortcoming of the prior art has been resolved with this invention by accessing generally available information that even experienced users with intent to commit an offense will find difficult or impossible to spoof or to provide misleading information: even if they would spoof the GPS location data or use a VPN, still the system and method of this invention would detect in a high percentage, e.g. in an extremely high percentage, the true country where the wireless mobile device truly is.

Criminal acts such as ML/TF/Fraud generate important losses to the financial institutions and to society overall, such as for example but not limited to, card fraud in the region of 6%-7% of revenue, that means that financial institutions lost or can lose up to 7 cents for every dollar in overall card transactions, according the publication by Statista.com with title “Fraud losses per 100 U.S. dollars of total card sales worldwide from 2010 to 2019, with forecasts to 2027” and Published by M. Szmigiera, on Jun. 4, 2021. (https://www.statista.com/statistics/1080685/global-card-fraud-losses-forecast/).

Although new digital onboarding processing methods are perfectly workable as a business as they were functional, the fact is that they do not provoke a safer or better result in terms of trust compared to the legacy methods, and they do however not address the shortcomings addressed by this invention.

This invention resolves all the prior art shortcomings herein mentioned and in particular, this invention increases the reliability of fraud detection methods, as not only does this invention allow legacy and digital only financial institutions to have the same relevant information as in a physical visit to a branch, but it extracts more information that is then used to continuously track the risk factors over the time. Moreover, it is almost impossible for a person of one branch to know what another person of a different branch sees, thus leaving firms exposed to multiple accounts being opened by a same person with the same or even different documents. It is also almost impossible that a person of a branch can identify the person in front of him as being totally certainly the same person on the photo ID document. This invention increases the reliability of the information collected from the user and reduces fraud and ML cases even further than the prior art.

### 3. Discussion of Related Art

EP3189653B1 discloses a computer-implemented method of fraud detection within a contact center, the method performed by a system of computer-based workstations, each workstation including a processor configured for:
monitoring activity of a plurality of agents attending to a plurality of workstations of a contact center; determining that a first agent at a first workstation of said contact center is not on a call at a first time;
determining that said first agent is accessing a client based resource at said first time, wherein said client based resource is associated with and managed by a client at a back end server remote from said contact center,
wherein said client based resource is accessed by an electronic resource at said first workstation through a communication network;
collecting electronic evidence of said first workstation, wherein said electronic evidence is associated with potential fraudulent activity being conducted at said first workstation, wherein said potential fraudulent activity comprises unauthorized access by said first agent to said client based resource and occurs when: i) a first condition is satisfied when said first agent is not on said call at said first time and ii) a second condition is satisfied when said first agent is accessing said client based resource at said first time;
wherein said collecting electronic evidence comprises: determining identifying information for a scheduled agent assigned to said first workstation; capturing an image of a positioned agent located at said first workstation; cross-referencing said image of said positioned agent with said identifying information; and authenticating that said positioned agent is not said scheduled agent.

### SUMMARY OF THE INVENTION

The present invention was developed to solve the current real issues for (e.g. financial services) companies, more particularly companies which need to reduce their fraud levels, by resolving issues such as (i) reducing the fraud and money laundering risks during and after the onboarding process, (ii) improving the reliability of the information verification collected from the user, and (iii) reducing specifically the fraud cases in two ways, (a) by reducing the number of users with fake information during onboarding or thereafter at any time and (b) by improving the surveillance method of the financial transactions with higher reliability data checks of any individual transaction and potential related or associated transactions or related sending/receiving of part or whole names or related bank accounts or card data or source/destination countries/currencies.

The present invention is developed to overcome the shortcomings of the prior art and to offer the (e.g. financial) industry an automated way of resolving the shortcomings of the prior art specifically for the further reduction of potential fraud and to increase the scalability of new users onboarding and ongoing monitoring for fraud- and money laundering prevention.

According to a first aspect of the invention, there is provided a system including a plurality of internet enabled wireless mobile devices and at least one payments server device,
each respective internet enabled wireless mobile device including at least one respective transceiver being a respective cellular phone network transceiver, a respective non-transitory storage medium, and a respective computer program product embodied on the respective non-transitory storage medium, the respective computer program product executable on the respective internet enabled wireless mobile device to communicate with the payments server device and
the payments server device including at least one internet enabled interface, a server non-transitory storage medium, and a server computer program product embodied on the server non-transitory storage medium, the server computer program product executable on the payments server device to communicate with the internet enabled wireless mobile devices, and
   wherein the respective computer program product when executed on the respective internet enabled wireless mobile device uses a data communication channel to communicate with the payments server device through the internet and the respective computer program product of the respective internet enabled wireless mobile device is executable upon detection of any new data entered by a respective user, or upon detection of a respective user modifying any existing data on the respective internet enabled wireless mobile device, to trigger the respective computer program product to extract accessible user- and device-data from the respective internet enabled wireless mobile device, any such data extraction having been allowed by the respective user of the respective internet enabled wireless mobile device, and to send the extracted data to the payments server device, the payments server device configured to use the extracted data to decide if an account of the respective user at the payments server is allowed to execute transactions at the payments server;
   wherein the data extracted by the respective computer program product from the respective internet enabled wireless mobile device, is at least one or more of the following data
(a) cellular phone network transceiver Cell—Location or—Country data of the respective internet enabled wireless mobile device,
(b) Time zone city or region of the respective internet enabled wireless mobile device,
   wherein the Cell data is the cellular/mobile infrastructure Cell tower/cluster identification data of the cellular/mobile infrastructure Cell tower/cluster to which the respective internet enabled wireless mobile device pings to for potential emergency calls that would be initiated by the respective user of the respective wireless mobile device, even if such respective wireless mobile device would have no SIM or no active SIM or no call credit, such infrastructure returning to the respective wireless mobile device the Cell location if requested by an authorised wireless mobile device application, or returning the Cell country only to all other wireless mobile device applications of the respective wireless mobile device.

An advantage is that fraud is reduced in a system including a plurality of internet enabled wireless mobile devices and at least one payments server device, the plurality of internet enabled wireless mobile devices configured to communicate with the at least one payments server device.

The system may be one wherein the respective internet enabled wireless mobile device includes a GPS receiver and a SIM card, wherein the data extracted by the respective computer program product from the respective internet enabled wireless mobile device is at least one or more of the following data: internet enabled wireless mobile device-location data, -user entered data, -user provided photos, -transaction data, and
wherein in the event of user provided photos being the extracted data, then the payments server extracts one or more of the following data from such photos, if available: face of the person of the photo, individual printed data text and numbers if available such as names, surnames, ID type, ID number, date of birth, issue date, validity date, place of issue, place of birth, country of nationality, country of residency, and
wherein in the event of the location data being extracted, then the payments server computer program decides in the following priority which is the most likely country of the connection of the respective internet enabled wireless mobile device at each time the user interacts with the respective computer program of the respective internet enabled wireless mobile device, which is the first of the following that is available, to become the most likely location/country/region: (1) GPS location of the respective internet enabled wireless mobile device, (2) cellular phone network transceiver Cell Country of the respective internet enabled wireless mobile device, (3) Time zone city or region of the respective internet enabled wireless mobile device, (4) country of the respective wireless mobile device SIM in combination of the Roaming indicator available, (5) IP address, and
wherein in the event of a transaction request being received at the payments server from the respective internet enabled wireless mobile device, then the payments server computer program extracts additional location information if available, such as in the case of a physical point of sale (POS) payment type including the location of the POS transaction, and
   wherein the respective computer program product when executed on the respective internet enabled wireless mobile device configures the respective internet enabled wireless mobile device to transmit after each user interaction and after each transaction request, through the communication channel, the user entered data and the wireless device extracted data through the internet to the payments server, and when an acknowledgement is received from the payments server then the respective internet enabled wireless mobile device stops sending data but if not acknowledged within a predefined timeout it will resend the same data at the next available internet connection and
   wherein the payments server processes all the received data and decides if the respective internet enabled wireless mobile device with a respective computer program product is allowed to further interact with the respective computer program product of the respective internet enabled wireless mobile device or in the event of a transaction request if that transaction is allowed to be executed or not, based on one or more of the following decisions by the computer program of the payments server: (1a) allow the user to interact if the most likely location/country/region is within a list of allowed countries/regions of a lookup table in the non-transitory memory of the payments server, (1b) allow the user to interact if the data provided by the user is correct compared to the data extracted by the computer program of the respective internet enabled wireless mobile device and correct compared to the data of all users stored at the non-transitory memory of the the payments server, (2a) allow the transaction to be executed or accessed by the user if the location data from the transaction is of the allowed list of countries/regions of a lookup table in the non-transitory memory of the the payments server, (2b) the transaction data is correct compared to the data of all users stored at the non-transitory memory of the payments server.

The system may be one wherein each of the plurality of the internet enabled wireless mobile devices is a mobile phone, or a smartphone, or a wireless tablet Computer, or a portable computer or a desktop Computer.

The system may be one wherein the cellular phone network transceiver of the respective internet enabled wireless mobile device is a cellular phone network transceiver or a 2G, 3G, 4G, 5G transceiver or a Wideband Code Division Multiple Access (WCDMA) transceiver or a personal communications service (PCS) transceiver or any such future similar cellular phone network wireless technology transceiver.

The system may be one wherein the respective computer program product when executed on the respective internet enabled wireless mobile device will configure that respective internet enabled wireless mobile device to detect the location/country/country from where the respective internet enabled wireless mobile device is accessing the mobile network or the internet, so as to allow the Payments Server computer program product to allow or to block the user interaction with the respective computer program product or to allow or block an incoming or outgoing transaction, based on a LOCATION SCORING range to block the user interaction with the respective computer program product, or the transaction, for a location score below a first threshold, or to request a Payments Server compliance officer manual review for a location score between the first threshold and a second threshold, or to allow the user interaction with the respective computer program product, or the transaction, to continue for a location score above a third threshold.

The system may be one wherein the respective computer program product when executed on the respective internet enabled wireless mobile device will configure that respective internet enabled wireless mobile device to detect the data entered by the user and the data extracted from the respective internet enabled wireless mobile device so as to allow the Payments Server computer program product to allow or to block the user interaction with the respective computer program product or to allow or block an incoming or outgoing transaction, based on a so called DATA COLLISION

SCORING range to block below a data collision score below a first threshold, or to request a Payments Server compliance officer manual review for a data collision score between the first threshold and a second threshold, or to allow to continue for a data collision score above a third threshold, such as but not limited to when the face of the user extracted from the photo provided by the user matches one or more other accounts of other users in the Payments Server.

The system may be one wherein the respective computer program product when executed on the respective internet enabled wireless mobile device will configure that respective internet enabled wireless mobile device to detect the data entered by the user and the data extracted from the respective internet enabled wireless mobile device so as to allow the Payments Server computer program product to allow or to block the user interaction with the respective computer program or to allow or block an incoming or outgoing transaction, based on a DATA CONSISTENCY SCORING range to block for a data consistency score below a first threshold, or to request a Payments Server compliance officer manual review for a data consistency score between the first threshold and a second threshold, or to allow to continue for a data consistency score above a third threshold, such as but not limited to when one or more of the data entered by the user is not matching fully with the data extracted from the data extracted from the photo or from the data available from the Payments Server.

The system may be one wherein the respective computer program product when executed on the respective internet enabled wireless mobile device, encrypts the payload of the communication channel when sending a communication and decrypts the payload of the data signalling communication channel when receiving a communication with a 128 bit or a 256 bit Advanced Encryption Standard (AES) cipher.

The system may be one including an ATM (Automated Teller Machine) configured to communicate with the system payments server device, and/or to communicate with the plurality of internet enabled wireless mobile devices.

The system may be one wherein the system payments server device is configured to use information received by the respective computer program product when executed on the respective internet enabled wireless mobile device, the information being received from user input into a form displayed on a screen of the respective internet enabled wireless mobile device.

The system may be one wherein the system payments server device is configured to use a user photo received by the respective computer program product when executed on the respective internet enabled wireless mobile device, the user photo being received from a camera integral to the respective internet enabled wireless mobile device.

The system may be one wherein the system payments server device is configured to use a user video file received by the respective computer program product when executed on the respective internet enabled wireless mobile device, the user video file being generated using a video camera integral to the respective internet enabled wireless mobile device, and being generated using the respective internet enabled wireless mobile device.

The system may be one wherein the system payments server device is configured to use at least four different methods of scoring with respect to a user internet enabled wireless mobile device, including location scoring, data collision scoring, data consistency scoring, and transaction scoring, and to adopt a decision whether or not to allow processing of a request received from the respective computer program product when executed on the user internet enabled wireless mobile device, based on the at least four different methods of scoring with respect to the user internet enabled wireless mobile device.

Further aspects of the first aspect of the invention are defined in the Claims dependent on the first independent Claim. An advantage is that fraud is reduced in a system including a plurality of internet enabled wireless mobile devices and at least one payments server device, the plurality of internet enabled wireless mobile devices configured to communicate with the at least one payments server device.

According to a second aspect of the invention, there is provided a computer-implemented method carried out using a system, the system comprising
(a) a plurality of internet enabled wireless mobile devices, each respective wireless mobile device including at least one respective transceiver being a cellular phone network transceiver, a respective non-transitory storage medium, and a respective computer program product embodied on the respective non-transitory storage medium, the respective computer program product executing on the respective internet enabled wireless mobile device to communicate with a payments server device and
(b) the payments server device including at least one internet enabled interface, a server non-transitory storage medium, and a server computer program product embodied on the server non-transitory storage medium, the server computer program product executing on the payments server device to communicate with the plurality of internet enabled wireless mobile devices, the method including the steps of:
(i) the respective computer program product executing on the respective internet enabled wireless mobile device to use a data communication channel to communicate with the payments server device through the internet;
(ii) the respective computer program product of the respective internet enabled wireless mobile device executing to detect any newly entered user data or to detect an existing user modifying any existing data, to trigger that respective computer program product to extract accessible user- and device-data from the respective internet enabled wireless mobile device, any such data extraction being previously allowed by the respective user of the respective internet enabled wireless mobile device to be extracted;
wherein the data extracted by the respective computer program product from the respective internet enabled wireless mobile device is at least one or more of the following data: internet enabled wireless mobile device-location data, -user entered data, -user provided photos, -transaction data;
(iii) if user provided photos are extracted in step (ii), then the payments server extracts one or more of the following data from such photos, if available: face of the person of the photo, individual printed data text and numbers if available such as names, surnames, ID type, ID number, date of birth, issue date, validity date, place of issue, place of birth, country of nationality, country of residency;
(iv) if location data is extracted in step (ii), then the payments server computer program decides in the following priority order which is the most likely country of the connection of the respective internet enabled wireless mobile device at each time the user interacts with the respective computer program of the respective internet enabled wireless mobile device, in which the first of the following that is available becomes the most likely location/country/region: (1) GPS location of the respective internet enabled wireless mobile device, (2) the respective internet enabled wireless mobile device cellular phone network transceiver Cell Country, (3) Time zone city or region of the respective wireless mobile device, (4) country of the respective wireless mobile device SIM in combination with the Roaming indicator available, (5) IP address;
(v) if transaction data is available, then the payments server computer program extracts additional location information if available, such as in the case of a physical point of sale (POS) payment type extracting the location of the POS transaction;
(vi) the respective computer program product executing on the respective internet enabled wireless mobile device to configure that respective internet enabled wireless mobile device to transmit at each user interaction and at each transaction request, through the communication channel, the user entered data and the wireless device extracted data through the internet to the payments server, and when an acknowledgement is received from the payments server then the respective internet enabled wireless mobile device stops sending data but if not acknowledged within a predefined timeout the respective internet enabled wireless mobile device resends the same data at the next available internet connection and
(vii) the payments server processing all the received data and deciding if the internet enabled wireless mobile device with an executing computer program product is allowed to further interact with the respective computer program product of the respective internet enabled wireless mobile device, or in the event of a transaction request it decides if that transaction is allowed to be executed or not based on one or more of the following decisions by the computer program of the payments server: (1a) allow the user to interact if the most likely location/country/region is within the list of allowed countries/regions of a lookup table in the non-transitory memory of the payments server, (1b) allow the user to interact if the data provided by the user is correct compared to the data extracted by the respective computer program of the respective internet enabled wireless mobile device and correct compared to the data of all users stored at the non-transitory memory of the payments server, (2a) allow the transaction to be executed or accessed by the user if the location data from the transaction is on the list of allowed countries/regions of a lookup table in the non-transitory memory of the payments server, (2b) the transaction data is correct compared to the data of all users stored at the non-transitory memory of the payments server.

An advantage is that fraud is reduced in a system including a plurality of internet enabled wireless mobile devices and at least one payments server device, the plurality of internet enabled wireless mobile devices configured to communicate with the at least one payments server device.

The method may be one which is carried out using a system of any aspect of the first aspect of the invention.

Further aspects of the second aspect of the invention are defined in the Claims dependent on the second independent Claim. An advantage is that fraud is reduced in a system including a plurality of internet enabled wireless mobile devices and at least one payments server device, the plurality of internet enabled wireless mobile devices configured to communicate with the at least one payments server device.

According to a third aspect of the invention, there is provided a respective computer program product embodied on the respective non-transitory storage medium of any aspect of the first aspect of the invention.

According to a fourth aspect of the invention, there is provided a server computer program product embodied on the server non-transitory storage medium of any aspect of the first aspect of the invention.

### BRIEF DESCRIPTION OF THE FIGURES

Aspects of the invention will now be described, by way of example(s), with reference to the following Figures, in which:

FIG. 1 represents a diagram of a typical example system including the present invention, including an ANTIFRAUD SCORING system. The system shown comprises adapted wireless devices (AWD1 to AWDx), the cloud (Internet), an adapted transaction system (ATS) including a Payment Server Module (ATS_M) and optionally an adapted automated teller machine (ATM) (ATMy), where for example ATS and ATMy could be integrated as one and the same server or be provided as separate independent different geolocated cloud-based servers communicating between them through the internet respectively through communication channels 400.3 and 400.4.

Any such ATS, meaning a processing machine acting as a server in a fixed location connected through the internet (using communication channel 400.3) to the cloud (Internet), can process the financial transactions of the users, who communicate with the system server (ATS) through an adapted wireless device (AWD1 to AWDx) that is connected to the cloud (Internet) through communication channels 400.1 to 400.2 as an encrypted bidirectional channel and then through communication channel 400.3 to the ATS.

Any such adapted wireless device can be a mobile phone, tablet, smartphone or any such other device enabled to download an application including the “App SDK module” of an aspect of this invention, in which the “App SDK module” is embedded in the adapted wireless device and enables the adapted wireless device through the adapted mobile interface to communicate with the internet (cloud) through to the ATS server using encrypted bidirectional communications channels.

Any ATM (Automated Teller Machine) (ATM1 to ATMy) is connected to the cloud (Internet) through an encrypted bidirectional channel (400.4) using the ATM Server Module (ATMy_M) to communicate with the system payments processing server ATS, through communication channels 400.4 and 400.3 and/or to communicate with a user's device AWD1 to AWDx through communications channels 400.4 and 400.1 or 400.2

FIG. 2 represents a functional block diagram or flow-chart of an example method of calculation of the intermediate scoring of an example of the four different methods (location, data collision, data consistency, transaction scoring) and the adopted decision based on the final scoring with respect to the user.

FIG. 3 represents a flow-chart relating to one of the examples of the present invention for calculating the “location scoring” of a user, corresponding to FIG. 2.

FIG. 4 represents a flow-chart relating to one of the examples of the present invention for calculating the “Data Collision scoring” of a user, corresponding to FIG. 2.

FIG. 5 represents a flow-chart relating to one of the examples of the present invention for calculating the “Data Consistency scoring” of a user, corresponding to FIG. 2.

FIG. 6 represents a flow-chart relating to one of the examples of the present invention for calculating the “Transaction scoring” of a user, corresponding to FIG. 2.

FIG. 7 represents a functional block diagram or flow-chart of the prior art, to which FIG. 2 adds novel steps and methods, in examples of the system.

### DETAILED DESCRIPTION

There is provided a system, and a method of operating an anti-fraud scoring system, through the use of adapted wireless devices (AWD), an adapted transaction server (ATS) as per this invention, and an optional cloud server processing POS (point of Sale) or Automated Teller Machine (ATM) transactions. Aspects of the disclosures relate in particular to a system and method to calculate the risk associated with a user, to score the potential probability that such a user would potentially become, or is, a fraudster and obtain the evaluation in a numeric way (i.e. including SCORING), to allow the classification of users and to apply different antifraud protocols appropriate to particular risk levels as soon as a risk is detected. The system and method described in this disclosure explain what and how the information about the user is collected from the adapted wireless device (AWD) by different ways: for example information given by the user through a form, pictures of ID documents given by the user, information collected from the AWD through an SDK (App SDK module), the information collected from user interacting with the AWD through the proprietary interface of this invention (App SDK module) and from POS transactions and/or ATM transactions.

The AWD can be, but is not limited to, a mobile phone-, smartphone-, or wireless device-adapted as per this invention to facilitate the onboarding process and the incorporation of the SDK and the tools to fill in a form and send the pictures of the ID documents to the cloud server, and where such AWD communicates through a secure encrypted connection with the server that manages the processing of (e.g. all) the transactions of (e.g. all) AWDs connected to that ATS and/or ATMy server.

The AWD communicates with the transaction server, with which (e.g. all) the AWSs communicate, to execute (e.g. all) the payment transactions directly from and to the wallets of the AWD. Such wallet can be, but is not limited to, a bank account, a virtual sub-account of a bank account, a payment card account, a payment system virtual account, a corporate account or a sub-account from a 3rd party brand.

Other aspects of disclosures include enabling those adapted wireless devices (AWDs) as per this invention to collect data from other nearby users' devices (AWD1 to AWDx) using a proximity-based technology exchanging the nearby device user unique identifier and all the data collected by the SDK of that user device and sent to the server e.g. by user device AWD1 to the server ATS, when a nearby user device AWDx has no internet.

Secure transaction communications between adapted wireless devices and the system servers are facilitated through the wireless devices communicating through their “App SDK module 1 to x” of each device (AWD1 to AWDx) with the “payments Server module” of the adapted server (ATS) through a secured and encrypted connection (400.1 or 400.2 through 400.3).

The system requires that a user registers and complete a KYC (know your customer) or KYB (know your business) process to initiate the SCORING process. After the registration is complete, the SCORING system continues evaluating the user on every interaction between the user and the ANTIFRAUD SCORING SYSTEM, providing a same or a new SCORING result after each interaction.

This SCORING result can be between 0 and a predefined maximum value (MAX), and may be in 3 different ranges: HIGH-RISK (from 0 to Trigger 1), MEDIUM (from Trigger 1 to Trigger 2) and SAFE (from Trigger 2 to MAX).

If the SCORING is in the SAFE range, no antifraud measure is applied.

If the SCORING is in the HIGH-RISK range, the full antifraud automated measures are activated.

If the SCORING is in the MEDIUM range, some minimal basic antifraud automated measures are activated and a manual review by a compliance officer is required to determine if this user is set manually to a High or a Low-risk user profile.

This SCORING is the result of the average calculation of four different SCORINGs, based on four different criteria, shown for example in the drawings and associated text therein.

If one or more of the results are in the HIGH-RISK range, the SCORING is marked as HIGH-RISK.

If all the results are in the MEDIUM or SAFE ranges, the SCORING is the result of calculating the mean of all the SCORINGs.

The SCORING system collects data from information given by the user through a form, pictures of ID documents given by the user, information collected from one or more user devices (AWD1 to AWDx) through an SDK (App SDK module), the information collected from outgoing payments transactions and POS transactions and ATM transactions, and classifying (e.g. all) the collected information under the following four categories:

### a.—Location

The Location of the user is calculated using different sources to find the most probable location.

Through the data provided by the user we can use the country of residence and the country of nationality.

Through the SDK we collect from the one or more user devices AWD1 to AWDx data, such as but not limited to, the GPS position, IP address with temporary potential GPS location at that moment in time, device time zone, device connected infrastructure Cell tower or Cell cluster location or country, country of the Subscriber Identity Module (SIM) card and the status of the device roaming indicator.

(E.g All) this data is collected during every new login session by the user using the one or more devices (AWD1 to AWDx). In addition, the location data is extracted from (e.g. all) the transactions executed by the ATS, including (e.g. all) the incoming and outgoing transfers, and from (e.g. all) the transactions executed through a POS or an ATM.

The set of (e.g. all) these location data is introduced in the SCORING system, which returns the most probable country for the user, by assigning a higher to lowest scoring to the highest- to lowest-trusted location source.

Using the highest scoring location from the above method, then based on a list of countries rated by highest to lowest risk, the SCORING system returns a numerical evaluation result between 0 and MAX called LOCATION SCORING.

b.—Data collision

The Data Collision SCORING is calculated depending on the probability of finding a pre-existing user with the same data, or, in other words, the probability of being a new or existing account of a pre-existing user. Optionally the ANTIFRAUD SCORING SYSTEM can be configured not to allow more than one account per unique user, wherein one account is defined as a segregated server or segmentation thereof (ATS), for example one user account for private accounts, yet that same user can be the company representative of a corporate account on a different server ATSx or a different segmentation of server ATS.

The source of information is composed for example by name, surname, date of birth, type of document, date of expiration of the document, number of the document, photograph of the user, photograph of the document, email address, phone number, and optionally by device identifier.

AI (artificial intelligence) based facial recognition and OCR (Optical Character Recognition) processes may be applied to the different pictures collected from the user, allowing the comparison among the data collected from the form filled in by the user when he/she created the account or updated it or optionally at each login, and the data collected from the pictures.

After calculating e.g. the probability, a numerical SCORING is returned by the ANTIFRAUD SCORING SYSTEM (system) referred to in this disclosure as DATA COLLISION SCORING.

This SCORING may be calculated every time a new user is registered in the system, or every time a data of the previously mentioned data in this section is modified/updated or additional different data is added.

c.—Data consistency

The DATA CONSISTENCY SCORING may be calculated depending on the probability that all or part of the provided data are true and consistent with the rest of the information provided by the user and collected by the system from the user. The source of information is composed of parameters such as, but not limited to, name, surname, date of birth, email address, phone number, incoming and outgoing transactions, photograph of the user (e.g. selfie), photograph of the ID document, data of all the registered user devices, use of biometric login, type of ID document, number of ID document and expiration date of the ID document, optionally the date of issue of the ID document and optionally the data extracted by the “App SDK module” and the system server from the ID document and compared with the data filled in by the user.

AI based facial recognition and OCR processes may be applied to the different pictures/photos collected from the user, allowing the statistical comparison with the data collected from the form filled in by the user and the data collected from the user form and the pictures/photos (e.g. selfie of user face and/or ID including user face). After calculating the probability, a numerical SCORING is returned by the system, referred to in this disclosure as the DATA CONSISTENCY SCORING.

This SCORING may be calculated every time a new user is registered on the system, or every time data of the previously mentioned data in this section is modified/updated or added.

### d.—Financial Transactions

The TRANSACTIONS SCORING returns the probability of finding a fraudulent incoming or outgoing transaction in the history of transactions of the user.

The source of information to calculate this SCORING is based on all the financial transactions data received from—or executed by—the user.

Parameters such as, but not limited to, amount, currency, most probable location, sender identifier, receiver identifier, reference, date, time, payment method, frequency and relations between different potentially linked or related transactions are processed to obtain the scoring result.

After calculating the result, a numerical SCORING is returned by the system referred to in this disclosure as the TRANSACTIONS SCORING.

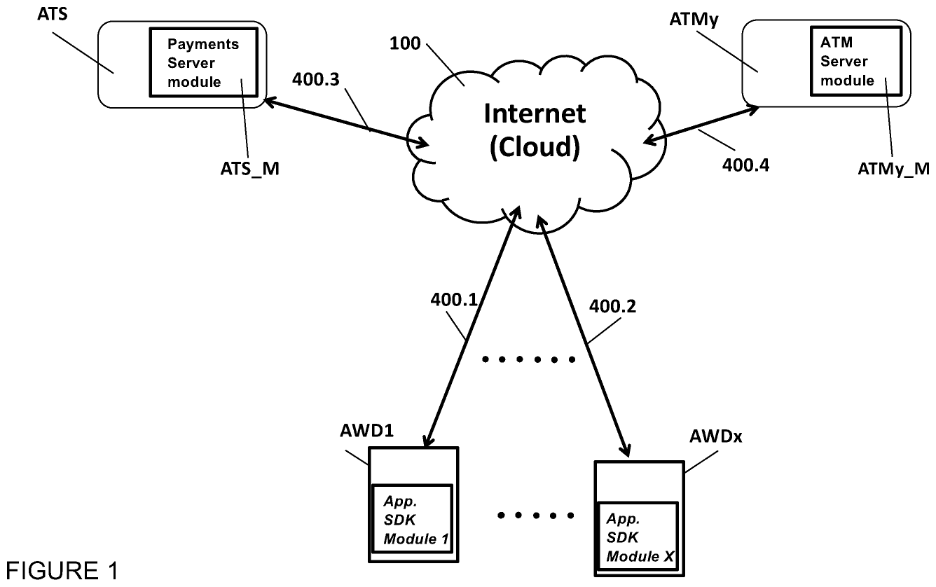

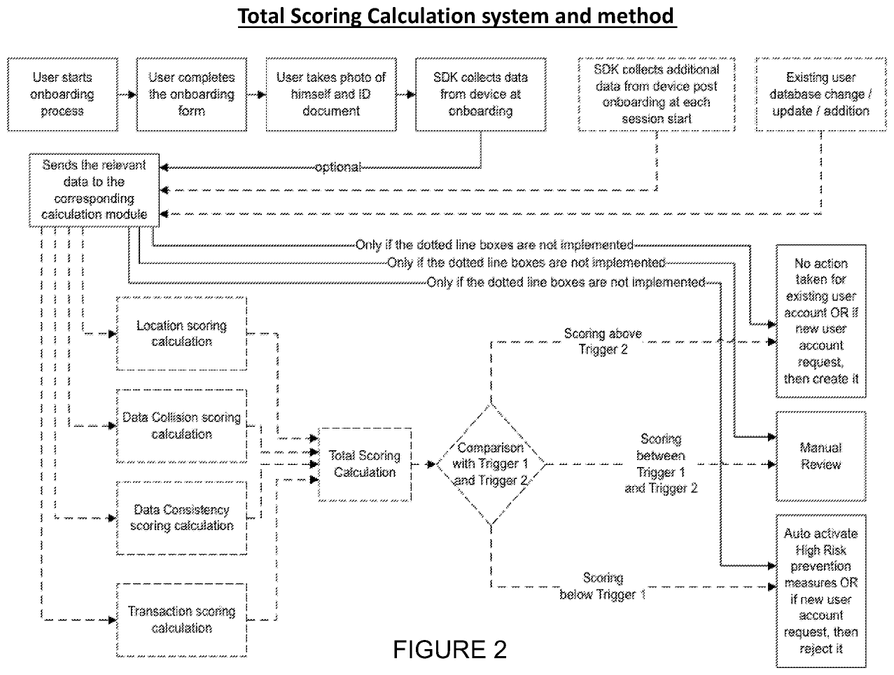

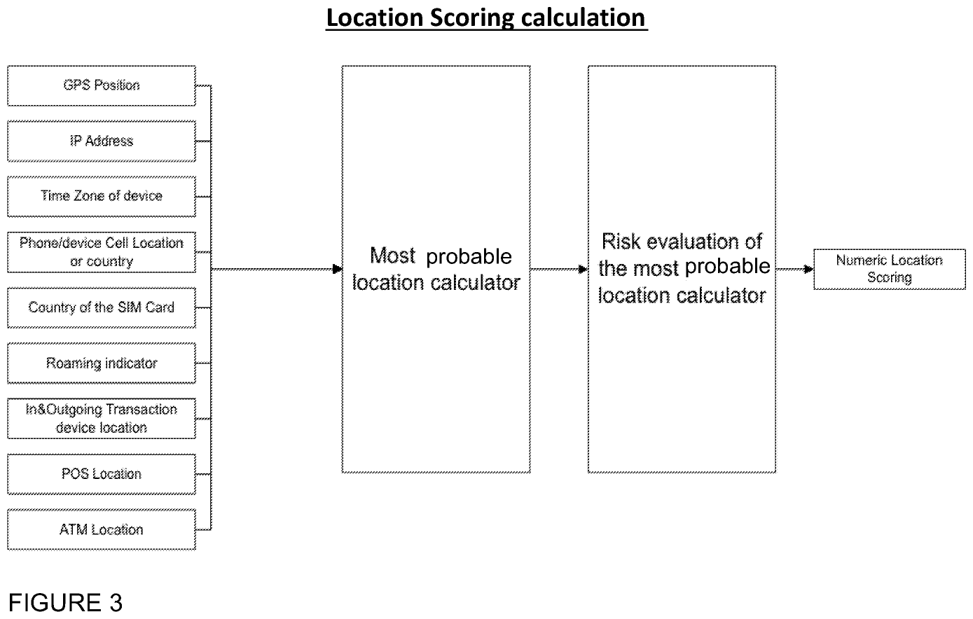

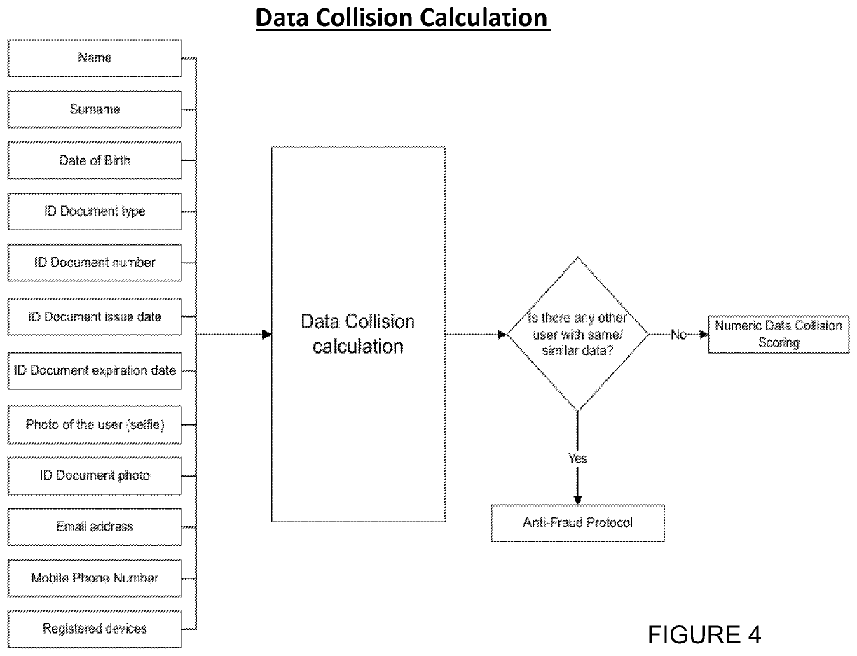

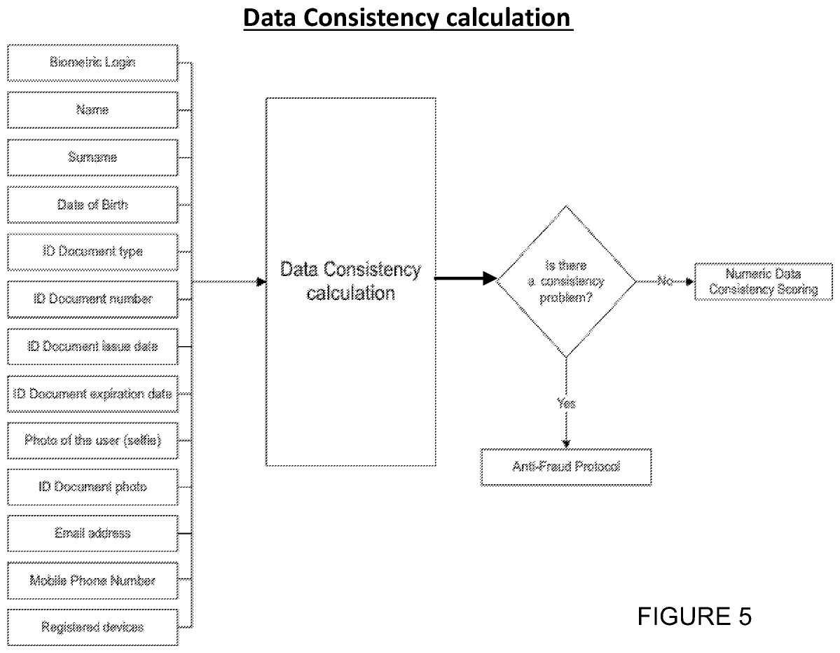

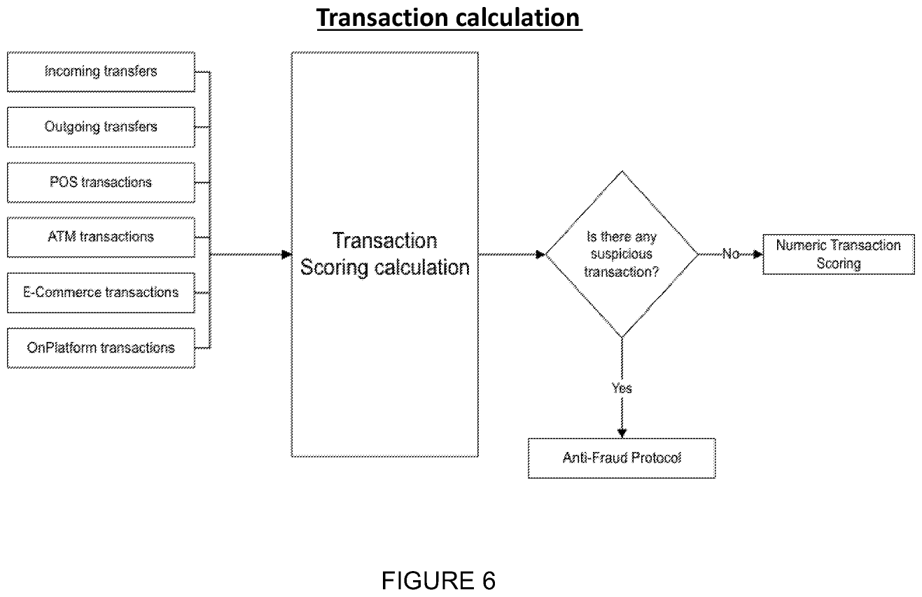

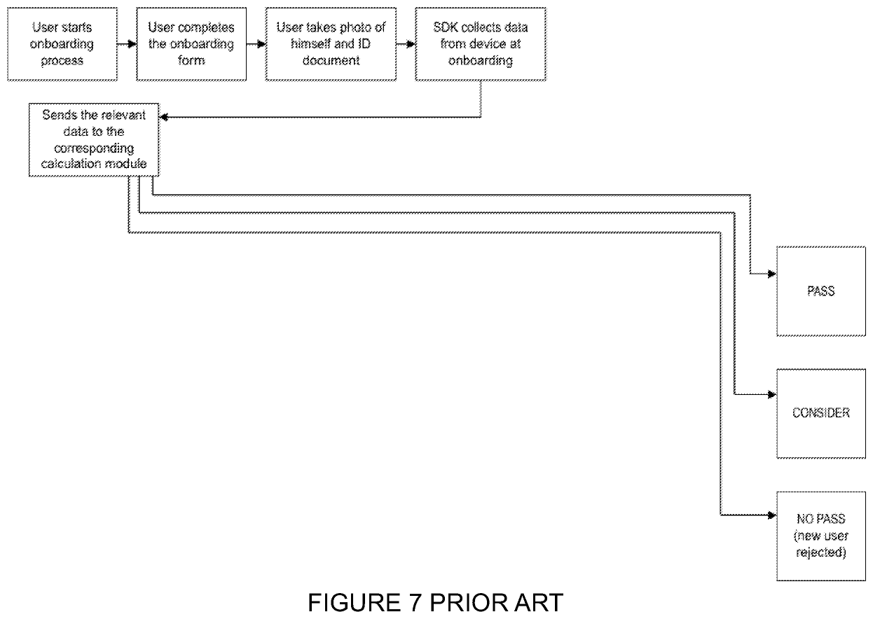

Specifically, FIG. 1 includes a typical example of the present invention, applicable amongst others but not limited to an onboarding system or method, or a payment processing system or method.

A system (e.g. in FIG. 1) comprises at least;
One or more cloud gateways to the Internet (100), where all the elements of the system interact through communications channels (400.1, 400.2, 400.3, 400.4), and one or more Adapted Transaction Servers (ATS) adapted as per this invention to include a proprietary “Payments Server module” (ATS_M), and
   one or more ATM servers (ATM1 to ATMy) adapted as per this invention to include a respective proprietary “ATM Server module” (ATMy_M) to send the transactions to the ATS server or the user devices (AWD1 to AWDx), and
   one or more wireless devices (AWD1, AWDx) adapted as per this invention to include a proprietary “App SDK module” (ASM_1 to ASM_x)), wherein
   when an onboarding process starts, the user sends the onboarding data through the “APP SDK module” to the “Payments Server module” e.g. by filling in a form and taking and sending a picture of his ID document.

At the same time, the “App SDK module” collects metadata from the wireless device and sends it all to the cloud server ATS through the bidirectional encrypted connection 400.1 and 400.3.

Wherein, the system calculates an initial scoring, and updates the scoring after any login or transaction made by the user based on four different criteria, namely: Location criteria, Data Collision criteria, Data Consistency criteria and Transaction criteria.

FIG. 2 represents a functional block diagram or flow-chart of an example method of calculating the intermediate scoring of the four different methods (location, data collision, data consistency, transaction scoring) and the final scoring of the user based on the four methods results.

This SCORING result can be between ZERO (0) and a predefined maximum value (MAX), and is stored in three different bands: HIGH-RISK (from 0 to Trigger 1), MEDIUM (from Trigger 1 to Trigger 2) and SAFE (from Trigger 2 to MAX).

If the SCORING is in the SAFE range, no protective measures are applied, so no actions are taken for existing users or, in case of a new user request, the account is created.

If the SCORING is in the HIGH-RISK range, the antifraud or anti-money laundering measures are automatically activated or, in case of a new user request, the account request is rejected.

If the SCORING is in the MEDIUM range, some manual reviews can be required from a member of the anti-fraud or Compliance team.

This SCORING is the result of calculating separately four different SCORINGs, based on the four above mentioned different criteria or methods.

If one or more of the results are in the HIGH-RISK range, the SCORING of that user and all his associated accounts or products are marked as HIGH-RISK.

If all the results are in the MEDIUM or SAFE ranges, the SCORING is the result of calculating the mean (average) of all the four SCORINGs.

The dotted lines and boxes in FIG. 2 represent the parts which are new in aspects of this invention.

FIG. 3 represents a flow-chart of one of the examples of the present disclosure for calculating the “location scoring” of a user, corresponding to FIG. 2.

The Location of the user is calculated using different sources to identify the most probable location based on the highest trust source that provides location information, as some of the extracted different location methods may not provide any information.

Through the data provided by the user, the country of residence and the country of nationality is verified against our different auto extraction methods to verify if the user is trustworthy or not based on the data he provided, meaning checking if there is a mismatch between the country, he/she entered as his/her country of residence or nationality and the most likely respective country extracted by the methods of this invention.

Through the “App SDK module” of AWD1 (e.g. of FIG. 1) data is collected, such as the GPS location, IP address, time zone, connected mobile network Cell location/country, country of the SIM card and the status of the roaming flag amongst others. (e.g. All) this data is collected in (e.g. every) login session of the user, for the one or more devices AWD1 to AWDx. In addition, the location data may be extracted from (e.g. all) the incoming and outgoing transactions executed by the ATS through the “Payments Server module” (e.g. of FIG. 1), including from (e.g. all) the transactions executed by an ATMy through the “ATM server module” (e.g. of FIG. 1). (e.g. All) these location data from the previous mentioned sources and methods are introduced in the SCORING system which then may return the most probable country for the user, meaning the most trusted country from all available sources.

Based on a list of countries rated by risk, the SCORING system returns also a numerical evaluation between 0 and MAX called LOCATION SCORING.

FIG. 4 represents a flow-chart of one of the examples of the present disclosure for calculating the “Data Collision scoring” of a user, corresponding to FIG. 2.

The Data Collision SCORING is calculated as the statistical probability of the new user data being the same user as any existing account, when compared to any pre-existing user data with the same data or similar data, or, in other words, the probability of a new account being the same user as any existing account, scored from higher to lower probability of data matches.

The source of information is composed e.g. by name, surname, date of birth, type of document, date of issue or expiration of the document, number of the document, photograph of the user, photograph of the document, email address, phone number, registered users' devices identifier.

AI based facial recognition and OCR processes are applied to the different pictures collected from the user, allowing the comparison among the data collected from the form filled in by the user and the data collected from the pictures and the digitized ID document where (e.g. all) the relevant data is all extracted from, for example, the ID photo, ID dates of issue & Expiration, ID type, name & surname, country of residency, nationality if available, and so forth. The digitally extracted data from the ID document and the corresponding data entered by the user are compared to establish the trust score of that user and both data are separately checked against existing user account data.

After calculating the probability, a numeric SCORING is returned e.g. by the method of FIG. 4, also referred to in this disclosure as DATA COLLISION SCORING.

This SCORING is calculated for example every time a new user is attempting to register on the system, or every time a data of the corresponding user account is modified/updated or added over time.

FIG. 5 represents a flow-chart of one of the examples of the present disclosure for calculating the “Data Consistency scoring” of a user, corresponding to FIG. 2.

The DATA CONSISTENCY SCORING is calculated e.g. based on the probability principle, verifying the likelihood of each and all individual data provided by the user are considered true and consistent with all the rest of the information provided by the user and consistent with the corresponding information collected by the system or method used with respect to the user device.

The source of information is composed by parameters, such as but not limited to, name, surname, date of birth, email address, mobile phone number, incoming and outgoing transactions, photograph of the user (e.g. selfie), photograph of the ID document, unique identifiers of all registered devices to that user, digital biometric login data, type of ID document, number of ID document, and issue/expiration date of the ID document.

AI based facial recognition and OCR processing algorithms may also be applied to the different photos collected from the user, allowing the automated verification of the level of correlation between the data collected from the form filled in by the user and the data the system extracts from the collected photos provided by the user, in example auto extracting by AI from the ID photo the following info: name, surname, ID nr, ID type, issue/expiration date, nationality, country of issue, residence address and so forth and comparing it to the information filled in the form by the user, to determine the correlation of each item and to provide an overall correlation score to determine the DATA CONSISTENCY SCORING.

After calculating the probability (e.g. correlation), a numerical SCORING is returned by the system, referred to in this disclosure also as the DATA CONSISTENCY SCORING.

This SCORING is calculated e.g. every time a new user is registered on the system, or every time a data of the data previously mentioned in this method is modified/updated or added.

FIG. 6 represents the flow-chart of one of the examples of the present disclosure for calculating the “TRANSACTIONS SCORING” of a user, corresponding to FIG. 2.

The TRANSACTIONS SCORING returns the probability (e.g. correlation) of detecting a potential fraudulent transaction in the history of transactions of the user and/or any potentially related or associated accounts to that same user where the correlation between users is high.

The source of information to calculate this SCORING for example is based on all the financial transactions received or executed by the user account and/or any potentially related or associated accounts to that same user where the correlation between users is high.

Parameters used by the TRANSACTIONS SCORING are for example, but not limited to, the following, transaction-: amount, currency, location, sender name or account/card number, receiver name or account/card number, reference, date, time, payment method, most probable location or country/state or time zone, frequency, and relations among different transactions are correlated by the TRANSACTIONS SCORING method to obtain the most likely correlation scoring result.

After calculating the result, a numerical SCORING is returned by the system, referred to in this disclosure as the TRANSACTIONS SCORING.

An advantage of the invention is that it provides for the development of a more reliable anti-fraud/anti-money laundering onboarding process and allows for continuous monitoring of user accounts post account creation.

In the prior art, it is common to find onboarding process with: users with multiple accounts with the same or similar data, users selling legitimate accounts for criminal purposes, fake ID documents used in the KYC/KYB processes, users with multiple accounts with fake identities as in the ID document not corresponding to the actual person using that user account, legitimate users doing transactions with wrong sender/receiver data, users residing in countries thus being out of the regulatory jurisdiction, users with fake/temporary emails, users with inconsistent information or users handling accounts from other users, which is just mentioning a few of the shortcomings of the prior art.

With this invention, a (e.g. financial services) company can collect increased reliable information from their customers and with a higher probability ensure than the collected data is consistent with the transactions and behaviour of the user, as required by regulations of: Know Your Client (KYC) or Know Your Business (KYB), Anti-Fraud protection to innocent users, anti-money laundering (AML), and anti-terrorist financing.

This invention provides improvements over the prior art which increase the reliability when scaling online users' acquisitions through onboarding processes that incorporate part or all of the methods or system of this invention, thus reducing the cost of the otherwise negative impacts from increased fraud or ML to (e.g. financial) institutions or payments processing companies. Furthermore, the methods, process and system of examples of this invention are applicable on existing user accounts, allowing to clean up legacy user accounts databases and to monitor going forward any change, correction or addition of any data associated to a user account to update the scorings referred to in this disclosure and to act accordingly, thus reducing potential fraud, money laundering or terrorist financing experienced by those companies using the methods, processes or system of examples of this invention.

FIG. 7 represents a functional block diagram or flow-chart of the prior art in relation to FIG. 2. The prior art in FIG. 7 typically focuses on KYC and extracts country location typically by SDK of GPS or the IP address at account creation and then decides on a PASS (which means No action taken), NO PASS (which means High Risk prevention measures are required i.e. not opening that user account), or CONSIDER (which means a Manual Review is required). As these checks are typically performed by 3rd parties by application programming interfaces (APIs), there are no further checks on an ongoing basis post account creation and the information considered and the systems and methods used during account creation or thereafter does not give the 3rd party access to all the database info from the requesting application programming interface (API) companies and thus they provide a limited checking and detection method and system. FIG. 2 of this disclosure shows the additional steps and additional data extractions, checks and calculations that are performed with examples of this invention, compared to the prior art shown in FIG. 7.

An example system and method of operating an anti-fraud scoring system is disclosed, including the use of adapted wireless devices, to calculate the potential risk a given user poses to the business where the user already has an account with the business, thereby correlating the potential of such user to become or already being a likely fraudster that already has or would likely commit an illegal financial act or a criminal financial offense. Such methods, processes or system of examples of this invention may process by artificial intelligence calculation, or correlation or comparison algorithms the data available from the user and extracted by the system from user input resulting in a unique identified user or user account SCORING, to allow the classification of users and all their corresponding associated accounts to that user or other users that correlated as potentially being similar or the same user as for other user accounts and apply the corresponding antifraud protocols at the time a risk is considered too high above a pre-defined threshold of the SCORING level. The system and method described in this disclosure, explain what and how the information about the user is collected through this invention “App SDK module” inside the adapted wireless device (AWD) of each user of this invention: such as but not limited to, information provided by the user through a form, photo(s) of ID document(s) and/or photo(s) of the user, information collected from the adapted AWD through the “App SDK module”, the information collected from online and/or POS transactions and/or ATM transactions.

An example system of this invention requires that a user was already an existing user of the system or registers as a new user and completes a KYC and/or KYB process to initiate the SCORING process on new users and processing/correlating the new user data against existing users data and optionally also auto updating the SCORING process regularly on all existing users of the system by processing/correlating each existing user data against each other existing users data in the system or against external databases. After a new user registration is completed, the SCORING system continues evaluating that same user e.g. on every interaction between the user and the system, updating that user risk SCORING result.

### Concepts

1. A system including at least one or more internet enabled wireless mobile device and at least one or more payments server,
the first internet enabled wireless mobile device including at least one transceiver being a cellular phone network transceiver, a first non-transitory storage medium, and a first computer program product embodied on the first non-transitory storage medium, the first computer program product executable on the first internet enabled wireless mobile device to communicate with the payments server and
a payments server device including at least one internet enabled interface, a non-transitory storage medium, and a computer program product embodied on the server non-transitory storage medium, the server computer program product executable on the payments server device to communicate with the internet enabled wireless mobile devices, and
   wherein the first computer program product when executed on the first internet enabled wireless mobile device uses a data communication channel to communicate with the payments server device through the internet and the first computer program product of the first internet enabled wireless mobile device is executable upon detection of any new user entered data or an existing user modifying any existing data and triggers that first computer program product to extract the accessible user- and device-data from the first internet enabled wireless mobile device, any such data extraction having been allowed by the user of the first internet enabled wireless mobile device, and
   wherein the data extracted by the first computer program product from the first internet enabled wireless mobile device, or any such other wireless device of the system, is at least one or more of the following data
(a) cellular phone network transceiver Cell—Location or—Country of the internet enabled wireless mobile device,
(b) Time zone city or region of the internet enabled wireless mobile device, wherein the Cell is the cellular/mobile infrastructure Cell tower/cluster to which the internet enabled wireless mobile device pings to for potential emergency calls that would be initiated by the user of the wireless mobile device, even if such wireless mobile device would have no SIM or no active SIM or no call credit, such infrastructure returning to the wireless mobile device the Cell location if requested by an authorised wireless mobile device application, or retuning the Cell country only to all other wireless mobile device applications.

2. The system of Concept 1, wherein the data extracted by the first computer program product from the first internet enabled wireless mobile device, or any such other wireless device of the system, is at least one or more of the following data: internet enabled wireless mobile device-location data, -user entered data, -user provided photos, -transaction data, and
wherein in the event of user provided photos, then the payments server extracts one or more of the following data from such photos, if available: face of the person of the photo, individual printed data text and numbers if available such as names, surnames, ID type, ID number, date of birth, issue date, validity date, place of issue, place of birth, country of nationality, country of residency, and
wherein in the event of the extracted location data, then the payments server computer program decides in the following priority which is the most likely country of the connection of the first internet enabled wireless mobile device at each time the user interacts with the computer program of the first internet enabled wireless mobile device, namely in this priority of the 1st of the following that is available becomes the most likely location/country/region and if not available then the next becomes the most likely: (1) GPS location of the internet enabled wireless mobile device, (2) cellular phone network transceiver Cell Country of the internet enabled wireless mobile device, (3) Time zone city or region of the internet enabled wireless mobile device, (4) country of the wireless mobile device SIM in combination of the Roaming indicator available, (5) IP address, and
wherein in the event of the transaction data, then the payments server computer program extracts additional location information if available, such as in the case of a physical point of sale (POS) payment type extracting the location of the POS transaction, and
   wherein the first computer program product when executed on the first internet enabled wireless mobile device configures that internet enabled wireless mobile device to transmit after each user interaction and after each transaction request, through the communication channel, the user entered data and the wireless device extracted data through the internet to the payments server, and when an acknowledgement is received from the payments server then the first internet enabled wireless mobile device stops sending data but if not acknowledged within a predefined timeout it will resend the same data at the next available internet connection and
   wherein the payments server processes all the received data and decides if the internet enabled wireless mobile device with an executed computer program product is allowed to further interact with the computer program of the internet enabled wireless mobile device or in the event of a transaction request if that transaction is allowed to be executed or not based on one or more of the following decisions by the computer program of the payments server: (1a) allow the user to interact if the most likely location/country/region is within the allowed list of countries/regions of a lookup table in the transitory memory of the computer program of the payments server, (1b) allow the user to interact if the data provided by the user is correct compared to the data extracted by the computer program of the internet enabled wireless mobile device and correct compared to the data of all users stored at the transitory memory of the computer program of the payments server, (2a) allow the transaction to be executed or accessed by the user if the location data from the transaction is of the allowed list of countries/regions of a lookup table in the transitory memory of the computer program of the payments server, (2b) the transaction data is correct compared to the data of all users stored at the transitory memory of the computer program of the payments server.

3. The system of Concept 1, wherein each of the first internet enabled wireless mobile device and the second internet enabled wireless mobile device are a mobile phone, or a smartphone, or a wireless tablet Computer, or a portable computer or a desktop Computer.

4. The system of Concept 1, wherein the cellular phone network transceiver of the first internet enabled wireless mobile device and the cellular phone network transceiver of the second internet enabled wireless mobile device, are cellular phone network transceivers or 2G, 3G, 4G, 5G transceivers or Wideband Code Division Multiple Access (WCDMA) transceivers or personal communications service (PCS) transceivers or any such future similar cellular phone network wireless technology.

5. The system of Concept 1, wherein the computer program product when executed on the internet enabled wireless mobile device will configure that internet enabled wireless mobile device to detect the location/country/country from where the internet enabled wireless mobile device is accessing the mobile network or the internet, so as to allow the Payments Server computer program product to allow or to block the user interaction with the computer program product or to allow or block an incoming or outgoing transaction, based on a so called LOCATION SCORING range to block below a threshold 1, or to request a Payments Server compliance officer manual review between threshold 1 and 2, or to allow to continue above threshold 3.

6. The system of Concept 1, wherein the computer program product when executed on the internet enabled wireless mobile device will configure that internet enabled wireless mobile device to detect the data entered by the user and the data extracted from the internet enabled wireless mobile device so as to allow the Payments Server computer program product to allow or to block the user interaction with the computer program product or to allow or block an incoming or outgoing transaction, based on a so called DATA COLLISION SCORING range to block below a threshold 1, or to request a Payments Server compliance officer manual review between threshold 1 and 2, or to allow to continue above threshold 3, such as but not limited to when the face of the user extracted from the photo provided by the user matches one or more other accounts of other users in the Payments Server.

7. The system of Concept 1, wherein the computer program product when executed on the internet enabled wireless mobile device will configure that internet enabled wireless mobile device to detect the data entered by the user and the data extracted from the internet enabled wireless mobile device so as to allow the Payments Server computer program product to allow or to block the user interaction with the computer program or to allow or block an incoming or outgoing transaction, based on a so called DATA CONSISTENCY SCORING range to block below a threshold 1, or to request a Payments Server compliance officer manual review between threshold 1 and 2, or to allow to continue above threshold 3, such as but not limited to when one or more of the data entered by the user is not matching fully with the data extracted from the data extracted from the photo or from the data available of the Payments Server.

8. The system of Concept 1, wherein the first computer program product when executed on the first internet enabled wireless mobile device, and the second computer program product when executed on the second internet enabled wireless mobile device, encrypt the payload of the communication channel when sending it and decrypt the payload of the data signalling communication channel when receiving it with a 128 bit or a 256 bit Advanced Encryption Standard (AES) cipher, and encrypt the payload of the data communication channel when sending it and decrypt the payload of the data communication channel when receiving it with a 128 bit or a 256 bit AES cipher.

9. A method wherein,
a first internet enabled wireless mobile device including at least one transceiver being a cellular phone network transceiver, a first non-transitory storage medium, and a first computer program product embodied on the first non-transitory storage medium, the first computer program product executable on the first internet enabled wireless mobile device to communicate with a payments server device and
the payments server device including at least one internet enabled interface, a non-transitory storage medium, and a computer program product embodied on the server non-transitory storage medium, the server computer program product executable on the payments server device to communicate with the internet enabled wireless mobile devices, and
   wherein the first computer program product when executed on the first internet enabled wireless mobile device uses a data communication channel to communicate with the payments server device through the internet and the first computer program product of the first internet enabled wireless mobile device is executable upon detection of any new user entered data or an existing user modifying any existing data and triggers that first computer program product to extract the accessible user- and device-data from the first internet enabled wireless mobile device, any such data extraction being previously allowed by the user of the first internet enabled wireless mobile device to be extracted, and
   wherein the data extracted by the first computer program product from the first internet enabled wireless mobile device is at least one or more of the following data: internet enabled wireless mobile device-location data, -user entered data, -user provided photos, -transaction data, and
wherein in the event of user provided photos, then the payments server extracts one or more of the following data from such photos, if available: face of the person of the photo, individual printed data text and numbers if available such as names, surnames, ID type, ID number, date of birth, issue date, validity date, place of issue, place of birth, country of nationality, country of residency, and
wherein in the event of the extracted location data, then the payments server computer program decides in the following priority which is the most likely country of the connection of the first internet enabled wireless mobile device at each time the user interacts with the computer program of the first internet enabled wireless mobile device, namely in this priority of the 1st of the following that is available becomes the most likely location/country/region and if not available then the next becomes the most likely: (1) GPS location of the internet enabled wireless mobile device, (2) internet enabled wireless mobile device “cellular phone network transceiver Cell Country”, (3) Time zone city or region of the wireless mobile device, (4) country of the wireless mobile device SIM in combination of the Roaming indicator available, (5) IP address, and
wherein in the event of the transaction data, then the payments server computer program extracts additional location information if available, such as in the case of a physical point of sale (POS) payment type extracting the location of the POS transaction, and
   wherein the first computer program product when executed on the first internet enabled wireless mobile device configures that internet enabled wireless mobile device to transmit at each user interaction and at each transaction request, through the communication channel, the user entered data and the wireless device extracted data through the internet to the payments server, and when an acknowledgement is received from the payments server then the first internet enabled wireless mobile device stops sending data but if not acknowledged within a predefined timeout it will resend the same data at the next available internet connection and
   wherein the payments server processes all the received data and decides if the internet enabled wireless mobile device with an executed computer program product is allowed to further interact with the computer program of the internet enabled wireless mobile device or in the event of a transaction request it decides if that transaction is allowed to be executed or not based on one or more of the following decisions by the computer program of the payments server: (1a) allow the user to interact if the most likely location/country/region is within the allowed list of countries/regions of a lookup table in the transitory memory of the computer program of the payments server, (1b) allow the user to interact if the data provided by the user is correct compared to the data extracted by the computer program of the internet enabled wireless mobile device and correct compared to the data of all users stored at the transitory memory of the computer program of the payments server, (2a) allow the transaction to be executed or accessed by the user if the location data from the transaction is of the allowed list of countries/regions of a lookup table in the transitory memory of the computer program of the payments server, (2b) the transaction data is correct compared to the data of all users stored at the transitory memory of the computer program of the payments server.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A system including a plurality of internet enabled wireless mobile devices and at least one payments server device,
each respective internet enabled wireless mobile device including at least one respective transceiver being a respective cellular phone network transceiver, a respective non-transitory storage medium, and a respective computer program product embodied on the respective non-transitory storage medium, the respective computer program product executable on the respective internet enabled wireless mobile device to communicate with the payments server device and
the payments server device including at least one internet enabled interface, a server non-transitory storage medium, and a server computer program product embodied on the server non-transitory storage medium, the server computer program product executable on the payments server device to communicate with the internet enabled wireless mobile devices, and
wherein the respective computer program product when executed on the respective internet enabled wireless mobile device uses a data communication channel to communicate with the payments server device through the internet and the respective computer program product of the respective internet enabled wireless mobile device is executable upon detection of any new data entered by a respective user, or upon detection of a respective user modifying any existing data on the respective internet enabled wireless mobile device, to trigger the respective computer program product to extract accessible user- and device-data from the respective internet enabled wireless mobile device, any such data extraction having been allowed by the respective user of the respective internet enabled wireless mobile device, and to send the extracted data to the payments server device, the payments server device configured to use the extracted data to decide if an account of the respective user at the payments server is allowed to execute transactions at the payments server;
wherein the data extracted by the respective computer program product from the respective internet enabled wireless mobile device, is at least one or more of the following data
(a) cellular phone network transceiver Cell—Location or—Country data of the respective internet enabled wireless mobile device,
(b) Time zone city or region of the respective internet enabled wireless mobile device,
wherein the Cell data is the cellular/mobile infrastructure Cell tower/cluster identification data of the cellular/mobile infrastructure Cell tower/cluster to which the respective internet enabled wireless mobile device pings to for potential emergency calls that would be initiated by the respective user of the respective wireless mobile device, even if such respective wireless mobile device would have no SIM or no active SIM or no call credit, such infrastructure returning to the respective wireless mobile device the Cell location if requested by an authorised wireless mobile device application, or returning the Cell country only to all other wireless mobile device applications of the respective wireless mobile device.

2. The system of claim 1, the respective internet enabled wireless mobile device including a GPS receiver and a SIM card, wherein the data extracted by the respective computer program product from the respective internet enabled wireless mobile device is at least one or more of the following data: internet enabled wireless mobile device-location data, -user entered data, -user provided photos, transaction data, and
wherein in the event of user provided photos being the extracted data, then the payments server extracts one or more of the following data from such photos, if available: face of the person of the photo, individual printed data text and numbers if available such as names, surnames, ID type, ID number, date of birth, issue date, validity date, place of issue, place of birth, country of nationality, country of residency, and
wherein in the event of the location data being extracted, then the payments server computer program decides in the following priority which is the most likely country of the connection of the respective internet enabled wireless mobile device at each time the user interacts with the respective computer program of the respective internet enabled wireless mobile device, which is the first of the following that is available, to become the most likely location/country/region: (1) GPS location of the respective internet enabled wireless mobile device, (2) cellular phone network transceiver Cell Country of the respective internet enabled wireless mobile device, (3) Time zone city or region of the respective internet enabled wireless mobile device, (4) country of the respective wireless mobile device SIM in combination of the Roaming indicator available, (5) IP address, and
wherein in the event of a transaction request being received at the payments server from the respective internet enabled wireless mobile device, then the payments server computer program extracts additional location information if available, such as in the case of a physical point of sale (POS) payment type including the location of the POS transaction, and
wherein the respective computer program product when executed on the respective internet enabled wireless mobile device configures the respective internet enabled wireless mobile device to transmit after each user interaction and after each transaction request, through the communication channel, the user entered data and the wireless device extracted data through the internet to the payments server, and when an acknowledgement is received from the payments server then the respective internet enabled wireless mobile device stops sending data but if not acknowledged within a predefined timeout it will resend the same data at the next available internet connection and
wherein the payments server processes all the received data and decides if the respective internet enabled wireless mobile device with a respective computer program product is allowed to further interact with the respective computer program product of the respective internet enabled wireless mobile device or in the event of a transaction request if that transaction is allowed to be executed or not, based on one or more of the following decisions by the computer program of the payments server: (1a) allow the user to interact if the most likely location/country/region is within a list of allowed countries/regions of a lookup table in the non-transitory memory of the payments server, (1b) allow the user to interact if the data provided by the user is correct compared to the data extracted by the computer program of the respective internet enabled wireless mobile device and correct compared to the data of all users stored at the non-transitory memory of the payments server, (2a) allow the transaction to be executed or accessed by the user if the location data from the transaction is of the allowed list of countries/regions of a lookup table in the non-transitory memory of the payments server, (2b) the transaction data is correct compared to the data of all users stored at the non-transitory memory of the payments server.

3. The system of claim 1, wherein each of the plurality of the internet enabled wireless mobile devices is a mobile phone, or a smartphone, or a wireless tablet Computer, or a portable computer or a desktop Computer.

4. The system of claim 1, wherein the cellular phone network transceiver of the respective internet enabled wireless mobile device is a cellular phone network transceiver or a 2G, 3G, 4G, 5G transceiver or a Wideband Code Division Multiple Access (WCDMA) transceiver or a personal communications service (PCS) transceiver or any such future similar cellular phone network wireless technology transceiver.

5. The system of claim 1, wherein the respective computer program product when executed on the respective internet enabled wireless mobile device will configure that respective internet enabled wireless mobile device to detect the location/country/country from where the respective internet enabled wireless mobile device is accessing the mobile network or the internet, so as to allow the Payments Server computer program product to allow or to block the user interaction with the respective computer program product or to allow or block an incoming or outgoing transaction, based on a LOCATION SCORING range to block the user interaction with the respective computer program product, or the transaction, for a location score below a first threshold, or to request a Payments Server compliance officer manual review for a location score between the first threshold and a second threshold, or to allow the user interaction with the respective computer program product, or the transaction, to continue for a location score above a third threshold.

6. The system of claim 1, wherein the respective computer program product when executed on the respective internet enabled wireless mobile device will configure that respective internet enabled wireless mobile device to detect the data entered by the user and the data extracted from the respective internet enabled wireless mobile device so as to allow the Payments Server computer program product to allow or to block the user interaction with the respective computer program product or to allow or block an incoming or outgoing transaction, based on a so called DATA COLLISION SCORING range to block below a data collision score below a first threshold, or to request a Payments Server compliance officer manual review for a data collision score between the first threshold and a second threshold, or to allow to continue for a data collision score above a third threshold, such as but not limited to when the face of the user extracted from the photo provided by the user matches one or more other accounts of other users in the Payments Server.

7. The system of claim 1, wherein the respective computer program product when executed on the respective internet enabled wireless mobile device will configure that respective internet enabled wireless mobile device to detect the data entered by the user and the data extracted from the respective internet enabled wireless mobile device so as to allow the Payments Server computer program product to allow or to block the user interaction with the respective computer program or to allow or block an incoming or outgoing transaction, based on a DATA CONSISTENCY SCORING range to block for a data consistency score below a first threshold, or to request a Payments Server compliance officer manual review for a data consistency score between the first threshold and a second threshold, or to allow to continue for a data consistency score above a third threshold, such as but not limited to when one or more of the data entered by the user is not matching fully with the data extracted from the data extracted from the photo or from the data available from the Payments Server.

8. The system of claim 1, wherein the respective computer program product when executed on the respective internet enabled wireless mobile device, encrypts the payload of the communication channel when sending a communication and decrypts the payload of the data signalling communication channel when receiving a communication with a 128 bit or a 256 bit Advanced Encryption Standard (AES) cipher.

9. The system of claim 1, the system including an ATM (Automated Teller Machine) configured to communicate with the system payments server device, and/or to communicate with the plurality of internet enabled wireless mobile devices.

10. The system of claim 1, wherein the system payments server device is configured to use information received by the respective computer program product when executed on the respective internet enabled wireless mobile device, the information being received from user input into a form displayed on a screen of the respective internet enabled wireless mobile device.

11. The system of claim 1, wherein the system payments server device is configured to use a user photo received by the respective computer program product when executed on the respective internet enabled wireless mobile device, the user photo being received from a camera integral to the respective internet enabled wireless mobile device.

12. The system of claim 1, wherein the system payments server device is configured to use a user video file received by the respective computer program product when executed on the respective internet enabled wireless mobile device, the user video file being generated using a video camera integral to the respective internet enabled wireless mobile device, and being generated using the respective internet enabled wireless mobile device.

13. The system of claim 1, wherein the system payments server device is configured to use at least four different methods of scoring with respect to a user internet enabled wireless mobile device, including location scoring, data collision scoring, data consistency scoring, and transaction scoring, and to adopt a decision whether or not to allow processing of a request received from the respective computer program product when executed on the user internet enabled wireless mobile device, based on the at least four different methods of scoring with respect to the user internet enabled wireless mobile device.

14. A computer-implemented method carried out using a system, the system comprising
(a) a plurality of internet enabled wireless mobile devices, each respective wireless mobile device including at least one respective transceiver being a cellular phone network transceiver, a respective non-transitory storage medium, and a respective computer program product embodied on the respective non-transitory storage medium, the respective computer program product executing on the respective internet enabled wireless mobile device to communicate with a payments server device and
(b) the payments server device including at least one internet enabled interface, a server non-transitory storage medium, and a server computer program product embodied on the server non-transitory storage medium, the server computer program product executing on the payments server device to communicate with the plurality of internet enabled wireless mobile devices, the method including the steps of:
(i) the respective computer program product executing on the respective internet enabled wireless mobile device to use a data communication channel to communicate with the payments server device through the internet;
(ii) the respective computer program product of the respective internet enabled wireless mobile device executing to detect any newly entered user data or to detect an existing user modifying any existing data, to trigger that respective computer program product to extract accessible user- and device-data from the respective internet enabled wireless mobile device, any such data extraction being previously allowed by the respective user of the respective internet enabled wireless mobile device to be extracted;
wherein the data extracted by the respective computer program product from the respective internet enabled wireless mobile device is at least one or more of the following data: internet enabled wireless mobile device-location data, -user entered data, -user provided photos, -transaction data;
(iii) if user provided photos are extracted in step (ii), then the payments server extracts one or more of the following data from such photos, if available: face of the person of the photo, individual printed data text and numbers if available such as names, surnames, ID type, ID number, date of birth, issue date, validity date, place of issue, place of birth, country of nationality, country of residency;
(iv) if location data is extracted in step (ii), then the payments server computer program decides in the following priority order which is the most likely country of the connection of the respective internet enabled wireless mobile device at each time the user interacts with the respective computer program of the respective internet enabled wireless mobile device, in which the first of the following that is available becomes the most likely location/country/region: (1) GPS location of the respective internet enabled wireless mobile device, (2) the respective internet enabled wireless mobile device cellular phone network transceiver Cell Country, (3) Time zone city or region of the respective wireless mobile device, (4) country of the respective wireless mobile device SIM in combination with the Roaming indicator available, (5) IP address;
(v) if transaction data is available, then the payments server computer program extracts additional location information if available, such as in the case of a physical point of sale (POS) payment type extracting the location of the POS transaction;
(vi) the respective computer program product executing on the respective internet enabled wireless mobile device to configure that respective internet enabled wireless mobile device to transmit at each user interaction and at each transaction request, through the communication channel, the user entered data and the wireless device extracted data through the internet to the payments server, and when an acknowledgement is received from the payments server then the respective internet enabled wireless mobile device stops sending data but if not acknowledged within a predefined timeout the respective internet enabled wireless mobile device resends the same data at the next available internet connection and
(vii) the payments server processing all the received data and deciding if the internet enabled wireless mobile device with an executing computer program product is allowed to further interact with the respective computer program product of the respective internet enabled wireless mobile device, or in the event of a transaction request it decides if that transaction is allowed to be executed or not based on one or more of the following decisions by the computer program of the payments server: (1a) allow the user to interact if the most likely location/country/region is within the list of allowed countries/regions of a lookup table in the non-transitory memory of the payments server, (1b) allow the user to interact if the data provided by the user is correct compared to the data extracted by the respective computer program of the respective internet enabled wireless mobile device and correct compared to the data of all users stored at the non-transitory memory of the payments server, (2a) allow the transaction to be executed or accessed by the user if the location data from the transaction is on the list of allowed countries/regions of a lookup table in the non-transitory memory of the payments server, (2b) the transaction data is correct compared to the data of all users stored at the non-transitory memory of the payments server.

15. (canceled)

16. A respective computer program product embodied on a respective non-transitory storage medium, the respective computer program product executable on a respective internet enabled wireless mobile device including the respective non-transitory storage medium to communicate with a payments server device, the respective computer program product executable to:
(i) use a data communication channel to communicate with the payments server device through the internet;
(ii) detect any newly entered user data or to detect an existing user modifying any existing data, to trigger that respective computer program product to extract accessible user- and device-data from the respective internet enabled wireless mobile device, any such data extraction being previously allowed by the respective user of the respective internet enabled wireless mobile device to be extracted;
wherein the data extracted by the respective computer program product from the respective internet enabled wireless mobile device is at least one or more of the following data: internet enabled wireless mobile device-location data, -user entered data, -user provided photos, -transaction data;
(iii) to configure that respective internet enabled wireless mobile device to transmit at each user interaction and at each transaction request, through the communication channel, the user entered data and the wireless device extracted data through the internet to the payments server, and when an acknowledgement is received from the payments server then the respective internet enabled wireless mobile device stops sending data but if not acknowledged within a predefined timeout the respective internet enabled wireless mobile device resends the same data at the next available internet connection.

17. A server computer program product embodied on the server non-transitory storage medium, the server computer program product executable on the payments server device to communicate with a plurality of internet enabled wireless mobile devices, the server computer program product executable to:
(i) receive a communication using a data communication channel from an internet enabled wireless mobile device of the plurality of internet enabled wireless mobile devices;
(ii) receive user provided photos from the internet enabled wireless mobile device, and extract one or more of the following data from such photos, if available: face of the person of the photo, individual printed data text and numbers if available such as names, surnames, ID type, ID number, date of birth, issue date, validity date, place of issue, place of birth, country of nationality, country of residency;
(iii) receive location data from the internet enabled wireless mobile device, and decide in the following priority order which is the most likely country of the connection of the respective internet enabled wireless mobile device at each time the user interacts with the respective computer program of the respective internet enabled wireless mobile device, in which the first of the following that is available becomes the most likely location/country/region: (1) GPS location of the respective internet enabled wireless mobile device, (2) the respective internet enabled wireless mobile device cellular phone network transceiver Cell Country, (3) Time zone city or region of the respective wireless mobile device, (4) country of the respective wireless mobile device SIM in combination with the Roaming indicator available, (5) IP address;
(iv) receive transaction data from the internet enabled wireless mobile device, and extract additional location information if available, such as in the case of a physical point of sale (POS) payment type extracting the location of the POS transaction;
(v) receive through the communication channel, the user entered data and the wireless device extracted data through the internet;
(vi) process all the received data and decide if the internet enabled wireless mobile device with an executing computer program product is allowed to further interact with the respective computer program product of the respective internet enabled wireless mobile device, or in the event of a transaction request, to decide if that transaction is allowed to be executed or not based on one or more of the following decisions: (1a) allow the user to interact if the most likely location/country/region is within the list of allowed countries/regions of a lookup table in the non-transitory memory of the payments server, (1b) allow the user to interact if the data provided by the user is correct compared to the data extracted by the respective computer program of the respective internet enabled wireless mobile device and correct compared to the data of all users stored at the non-transitory memory of the payments server, (2a) allow the transaction to be executed or accessed by the user if the location data from the transaction is on the list of allowed countries/regions of a lookup table in the non-transitory memory of the payments server, (2b) the transaction data is correct compared to the data of all users stored at the non-transitory memory of the payments server.

18. The method of claim 14, the respective internet enabled wireless mobile device including a GPS receiver and a SIM card, wherein the data extracted by the respective computer program product from the respective internet enabled wireless mobile device is at least one or more of the following data: internet enabled wireless mobile device-location data, -user entered data, -user provided photos, -transaction data, and
wherein in the event of user provided photos being the extracted data, then the payments server extracts one or more of the following data from such photos, if available: face of the person of the photo, individual printed data text and numbers if available such as names, surnames, ID type, ID number, date of birth, issue date, validity date, place of issue, place of birth, country of nationality, country of residency, and
wherein in the event of the location data being extracted, then the payments server computer program decides in the following priority which is the most likely country of the connection of the respective internet enabled wireless mobile device at each time the user interacts with the respective computer program of the respective internet enabled wireless mobile device, which is the first of the following that is available, to become the most likely location/country/region: (1) GPS location of the respective internet enabled wireless mobile device, (2) cellular phone network transceiver Cell Country of the respective internet enabled wireless mobile device, (3) Time zone city or region of the respective internet enabled wireless mobile device, (4) country of the respective wireless mobile device SIM in combination of the Roaming indicator available, (5) IP address, and
wherein in the event of a transaction request being received at the payments server from the respective internet enabled wireless mobile device, then the payments server computer program extracts additional location information if available, such as in the case of a physical point of sale (POS) payment type including the location of the POS transaction, and
wherein the respective computer program product when executed on the respective internet enabled wireless mobile device configures the respective internet enabled wireless mobile device to transmit after each user interaction and after each transaction request, through the communication channel, the user entered data and the wireless device extracted data through the internet to the payments server, and when an acknowledgement is received from the payments server then the respective internet enabled wireless mobile device stops sending data but if not acknowledged within a predefined timeout it will resend the same data at the next available internet connection and
wherein the payments server processes all the received data and decides if the respective internet enabled wireless mobile device with a respective computer program product is allowed to further interact with the respective computer program product of the respective internet enabled wireless mobile device or in the event of a transaction request if that transaction is allowed to be executed or not, based on one or more of the following decisions by the computer program of the payments server: (1a) allow the user to interact if the most likely location/country/region is within a list of allowed countries/regions of a lookup table in the non-transitory memory of the payments server, (1b) allow the user to interact if the data provided by the user is correct compared to the data extracted by the computer program of the respective internet enabled wireless mobile device and correct compared to the data of all users stored at the non-transitory memory of the payments server, (2a) allow the transaction to be executed or accessed by the user if the location data from the transaction is of the allowed list of countries/regions of a lookup table in the non-transitory memory of the payments server, (2b) the transaction data is correct compared to the data of all users stored at the non-transitory memory of the payments server.

19. The method of claim 14, wherein each of the plurality of the internet enabled wireless mobile devices is a mobile phone, or a smartphone, or a wireless tablet Computer, or a portable computer or a desktop Computer.

20. The method of claim 14, wherein the cellular phone network transceiver of the respective internet enabled wireless mobile device is a cellular phone network transceiver or a 2G, 3G, 4G, 5G transceiver or a Wideband Code Division Multiple Access (WCDMA) transceiver or a personal communications service (PCS) transceiver or any such future similar cellular phone network wireless technology transceiver.

21. The method of claim 14, wherein the respective computer program product when executed on the respective internet enabled wireless mobile device configures that respective internet enabled wireless mobile device to detect the location/country/country from where the respective internet enabled wireless mobile device is accessing the mobile network or the internet, to allow the Payments Server computer program product to allow or to block the user interaction with the respective computer program product or to allow or block an incoming or outgoing transaction, based on a LOCATION SCORING range to block the user interaction with the respective computer program product, or the transaction, for a location score below a first threshold, or to request a Payments Server compliance officer manual review for a location score between the first threshold and a second threshold, or to allow the user interaction with the respective computer program product, or the transaction, to continue for a location score above a third threshold.
